(19) United States
(12) Patent Application Publication
(10) Pub. No.: US 2015/0063888 A1
(43) Pub. Date: Mar. 5, 2015

(54) SHEET CONVEYING APPARATUS, AND IMAGE FORMING APPARATUS INCLUDING SHEET CONVEYING APPARATUS

(71) Applicant: KYOCERA Document Solutions Inc., Osaka (JP)

(72) Inventor: Tomoya Hotani, Osaka-shi (JP)

(21) Appl. No.: 14/466,277

(22) Filed: Aug. 22, 2014

(30) Foreign Application Priority Data
Aug. 28, 2013 (JP) 2013-176603

(51) Int. Cl. G03G 15/00; B65H 5/22

(52) U.S. Cl. CPC G03G 15/2028; B65H 5/26; B65H 5/06; B65H 3/0669
USPC 399/381; 271/3.19

(57) ABSTRACT

A sheet conveying apparatus includes a first conveying path, a second conveying path and a third conveying path, a switching guide, a conveying roller, a driving mechanism, a transmission mechanism. The second conveying path and the third conveying path are formed by diverging from the first conveying path. The switching guide switches the conveying path between the second conveying path and the third conveying path. The switching guide enables to change between a first position in which the sheet is conveyed into the second conveying path and a second position in which the sheet is conveyed into the third conveying path. The conveying roller is arranged on the third conveying path to convey the sheet. The driving mechanism generates a rotational driving force that rotates the conveying roller. The transmission mechanism transmits the rotational driving force to the conveying roller in accordance with the position of the switching guide.

The application is based on Japanese Patent Application No. 2013-176603 filed with the Japan Patent Office on Aug. 28, 2013, the contents of which are incorporated herein by reference.

### BACKGROUND

The disclosure relates to a sheet conveying apparatus that conveys sheets and an image forming apparatus including the sheet conveying apparatus.

Image forming apparatuses that form images on sheets conventionally include a sheet conveying apparatus that conveys sheets. A sheet with an image formed on a surface of the sheet using an electrophotographic technique is discharged into a sheet discharging section provided in the apparatus main body of the image forming apparatus.

A technique is known which uses a first conveying path and a second conveying path arranged as conveying paths along which sheets with images formed thereon are conveyed to a sheet discharging section.

According to this technique, the first conveying path and the second conveying path each include a conveying roller arranged on the conveying path to convey sheets. Regardless of which of the conveying paths is used to convey sheets, both of the conveying rollers is rotated.

### SUMMARY

A sheet conveying apparatus according to an aspect of the disclosure includes a first conveying path, a second conveying path and a third conveying path, a switching guide, a conveying roller, a roller shaft, a driving mechanism, a transmission mechanism, and an position change mechanism. A sheet is conveyed along the first conveying path in a predetermined conveying direction. The second conveying path and the third conveying path are formed on a downstream side of the first conveying path in the conveying direction by diverging from the first conveying path so that the sheet is selectively conveyed along the second conveying path or along the third conveying path. The switching guide is arranged to extend in a sheet width direction crossing the conveying direction and switches the conveying path, to which the sheet conveyed from the first conveying path, between the second conveying path and the third conveying path. The switching guide enables an position thereof to be changed between a first position in which the sheet is conveyed into the second conveying path and a second position in which the sheet is conveyed into the third conveying path. The conveying roller is arranged on the third conveying path to convey the sheet conveyed from the first conveying path. The roller shaft is arranged to extend in the sheet width direction and axially supports the conveying roller rotatably. The driving mechanism generates a rotational driving force that rotates the conveying roller. The transmission mechanism disconnects transmission of the rotational driving force to the conveying roller in the first position of the switching guide and transmits the rotational driving force to the conveying roller in the second position of the switching guide. The position change mechanism changes the position of the switching guide between the first position and the second position.

Furthermore, an image forming apparatus according to another aspect of the disclosure includes an apparatus main body, an image forming section, and the sheet conveying apparatus. The image forming section is arranged in the apparatus main body to form a toner image on a sheet.

### BRIEF DESCRIPTION OF DRAWINGS

FIG. 1 is a perspective view showing the appearance of an image forming apparatus according to an embodiment of the disclosure;

FIG. 2 is a cross-sectional view schematically showing the internal structure of the image forming apparatus according to the embodiment of the disclosure;

FIG. 3 is a cross-sectional view of the periphery of a sheet conveying apparatus in the image forming apparatus according to the embodiment of the disclosure;

FIG. 4 is a cross-sectional view of the periphery of the sheet conveying apparatus in the image forming apparatus according to the embodiment of the disclosure;

FIG. 5 is an exploded perspective view of the sheet conveying apparatus according to the embodiment of the disclosure;

FIG. 6 is an exploded perspective view of the sheet conveying apparatus according to the embodiment of the disclosure;

FIG. 7 is a perspective view of a part of the sheet conveying apparatus according to the embodiment of the disclosure;

FIG. 8 is a perspective view of a part of the sheet conveying apparatus according to the embodiment of the disclosure;

FIG. 9 is a perspective view of the periphery of the sheet conveying apparatus in the image forming apparatus according to the embodiment of the disclosure;

FIG. 10 is a cross-sectional view of the periphery of a driving mechanism of the sheet conveying apparatus according to the embodiment of the disclosure;

FIG. 11 is a cross-sectional view of the periphery of the driving mechanism of the sheet conveying apparatus according to the embodiment of the disclosure;

FIG. 12 is a perspective view of the periphery of a switching guide of the sheet conveying apparatus according to the embodiment of the disclosure;

FIG. 13 is a perspective view of the periphery of the switching guide of the sheet conveying apparatus according to the embodiment of the disclosure;

FIG. 14 is an enlarged perspective view of the periphery of an position change mechanism of the sheet conveying apparatus according to the embodiment of the disclosure; and

FIG. 15 is an enlarged perspective view of the periphery of the position change mechanism of the sheet conveying apparatus according to the embodiment of the disclosure.

### DETAILED DESCRIPTION

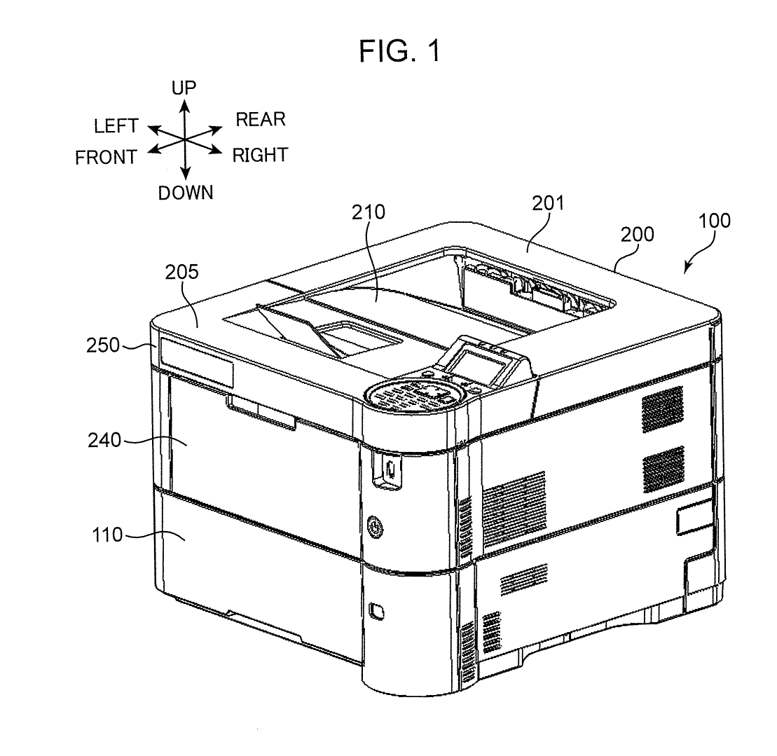

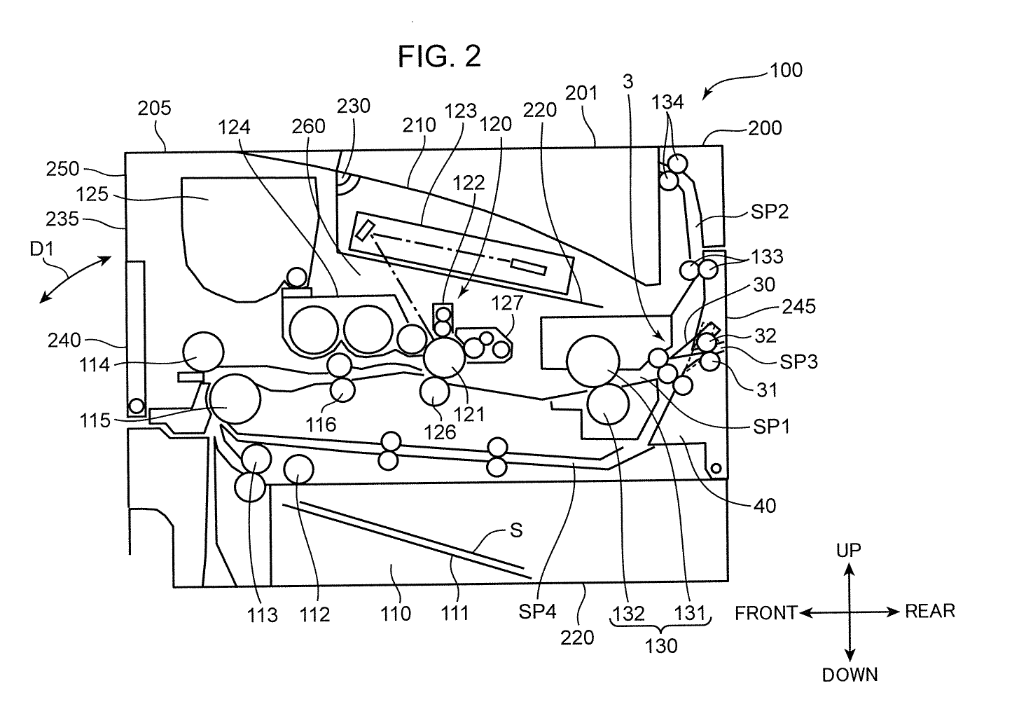

With reference to the drawings, an embodiment of the disclosure will be described below. FIG. 1 is a perspective view of a printer 100 (image forming apparatus) according to an embodiment of the disclosure. FIG. 2 is a cross-sectional view schematically showing the internal structure of the printer 100. The printer 100 shown in FIG. 1 and FIG. 2 is what is called a monochrome printer machine. However, in other embodiments, the image forming apparatus may be a color printer, a facsimile apparatus, a multifunction printer having the functions of a color printer and a facsimile apparatus, or another other apparatus that forms a toner image on a sheet. Terms such as “upper” and “lower”, “front” and “rear”, and “left” and “right” as used herein are simply intended for clear description and not for limitation of the principle of the image forming apparatus.

The printer 100 includes a housing 200 (apparatus main body) that houses various apparatuses for forming an image on a sheet S. The housing 200 includes an upper wall 201 that defines an upper surface of the housing 200, a bottom wall 220 (FIG. 2) that defines a bottom surface of the housing 200, a rear wall 245 (FIG. 2) between the upper wall 201 and the bottom wall 220, and a front wall 250 positioned in front of the rear wall 245. The housing 200 includes a main body internal space 260 (internal space) in which various apparatuses are arranged.

A sheet discharge section 210 (upper surface sheet discharge section) is arranged in a central portion of the upper wall 201. The sheet discharge section 210 includes an inclined surface that is inclined downward from a front portion toward a rear portion of the upper wall 201. The sheet S with an image formed thereon by an image forming section 120 described below is discharged into the sheet discharge section 210. Furthermore, a manual tray 240 is arranged in a central portion of the front wall 250 in an up-down direction.

The manual tray 240 is rotationally movable in the up-down direction (arrow D1 in FIG. 2) using a lower end of the manual tray 240 as a pivot.

The printer 100 includes a cassette 110, a pickup roller 112, a first sheet feeding roller 113, a second sheet feeding roller 114, a conveying roller 115, a registration roller pair 116, and the image forming section 120.

The cassette 110 internally houses sheets S. The cassette 110 includes a lift plate 111 supports the sheets S. The lift plate 111 is inclined so as to push leading edges of the sheets S up. The cassette 110 defines a part of the front wall 250 of the housing 200 and can be withdrawn forward with respect to the housing 200.

The pickup roller 112 is arranged above the leading edges of the sheets S pushed up by the lift plate 111. Rotation of the pickup roller 112 allows the sheet S to be conveyed from the cassette 110.

The first sheet feeding roller 113 is disposed on a downstream side of the pickup roller 112. The first sheet feeding roller 113 feeds the sheet S further downstream. The second sheet feeding roller 114 is disposed inside (behind) a pivot of the manual tray 240. The second sheet feeding roller 114 draws the sheet S on the manual tray 240 into the housing 200. A user can selectively use the sheet S housed in the cassette 110 or the sheet S placed on the manual tray 240.

The conveying roller 115 is disposed on a downstream side of the first sheet feeding roller 113 and the second sheet feeding roller 114 in a sheet conveying direction (hereinafter also simply referred to as a conveying direction) (“downstream in the sheet conveying direction” is hereinafter also simply referred to as “downstream”). The conveying roller 115 conveys the sheet S fed out by the first sheet feeding roller 113 and the second sheet feeding roller 114, further downstream.

The registration roller pair 116 has a function to correct diagonal conveyance of the sheet S. This allows an image formed on the sheet S to be aligned. The registration roller pair 116 feeds the sheet S to the image forming section 120 in a timely manner when the image forming section 120 forms an image.

The image forming section 120 is arranged in the housing 200 to form a toner image on the sheet S. The image forming section 120 includes a photosensitive drum 121 (image bearer), a charger 122, an exposure apparatus 123, a developing apparatus 124, a toner container 125, a transfer roller 126 (transfer section), and a cleaning apparatus 127.

The photosensitive drum 121 is shaped like a cylinder. An electrostatic latent image is formed on a circumferential surface of the photosensitive drum 121, and the photosensitive drum 121 bears a toner image associated with the electrostatic latent image. A predetermined voltage is applied to the charger 122 to substantially uniformly charge a circumferential surface of the photosensitive drum 121.

The exposure apparatus 123 delivers laser light to the circumferential surface of the photosensitive drum 121 charged by the charger 122. The laser light is delivered in accordance with image data output by an external apparatus such as a personal computer (not shown in the drawings) which is connected to the printer 100 for communication with the printer 100. As a result, an electrostatic latent image corresponding to the image data is formed on the circumferential surface of the photosensitive drum 121.

The developing apparatus 124 supplies toner to the circumferential surface of the photosensitive drum 121 with the electrostatic latent image formed thereon. The toner container 125 supplies toner to the developing apparatus 124. When the developing apparatus 124 supplies the toner to the photosensitive drum 121, the electrostatic latent image formed on the circumferential surface of the photosensitive drum 121 is developed (visualized). As a result, a toner image is formed on the circumferential surface of the photosensitive drum 121.

The transfer roller 126 is rotatably disposed in abutting contact with the circumferential surface of the photosensitive drum 121. When the sheet S conveyed from the registration roller pair 116 passes between the photosensitive drum 121 and the transfer roller 126, the toner image formed on the circumferential surface of the photosensitive drum 121 is transferred to the sheet S. The transfer roller 126 is arranged opposite the exposure apparatus 123 as viewed from the photosensitive drum 121.

The cleaning apparatus 127 removes toner remaining on the circumferential surface of the photosensitive drum 121 after the toner image is transferred to the sheet S.

The printer 100 further includes a fixing apparatus 130 (fixing section) arranged on a downstream side of the image forming section 120 in the conveying direction to execute a process of fixing the toner image on the sheet S. The fixing apparatus 130 includes a heating roller 131 (roller member) that melts the toner on the sheet S and a pressure roller 132 that brings the sheet S into tight contact with the heating roller 131. When the sheet S passes between the heating roller 131 and the pressure roller 132, the toner image is fixed to the sheet S. The heating roller 131 is rotationally driven by a driving mechanism 6 described below. The pressure roller 132 is rotated in conjunction with the heating roller 131.

The printer 100 further includes a conveying roller pair 133 disposed on a downstream side of the fixing apparatus 130 and a discharge roller pair 134 disposed on a downstream side of the conveying roller pair 133. The sheet S is conveyed upward by the conveying roller pair 133 and finally discharged from the housing 200 by the discharge roller pair 134. The sheet S discharged from the housing 200 is stacked on the sheet discharge section 210.

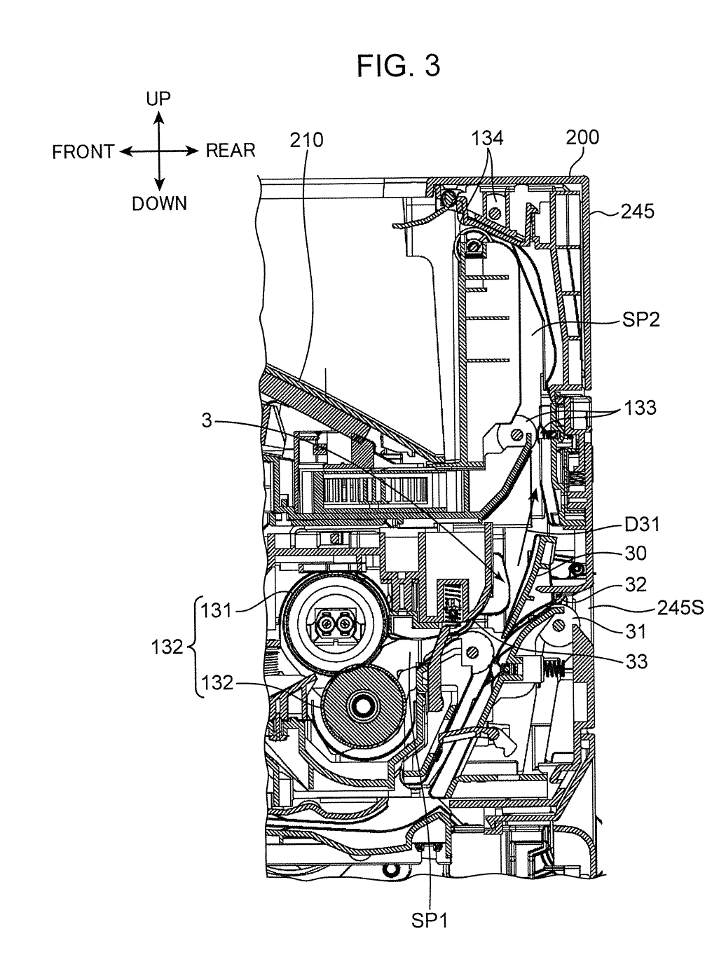

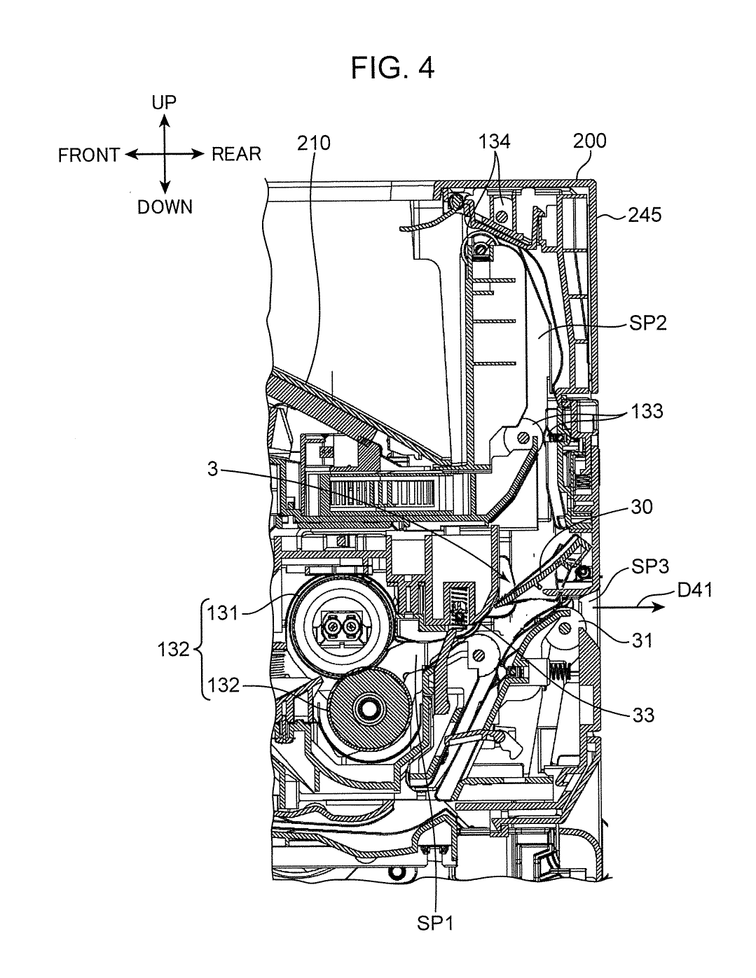

Moreover, the printer 100 includes a sheet conveying section 3 (sheet conveying apparatus). Now, with reference to FIG. 3 and FIG. 4 in addition to FIG. 2, the sheet conveying section 3 will be described. FIG. 3 and FIG. 4 are cross-sectional views of the sheet conveying section 3 of the printer 100 according to the present embodiment. FIG. 3 is a cross-sectional view showing that the sheet guide 30 described below is in a first position where the sheet S is discharged into the sheet discharge section 210. On the other hand, FIG. 4 is a cross-sectional view showing that the sheet guide 30 is in a second position where the sheet S is discharged by a discharge roller 31 described below and arranged on the rear wall 245 side.

As shown in FIG. 3 and FIG. 4, the sheet conveying section 3 conveys the sheet S on which the fixing process has been executed by the fixing apparatus 130. The sheet conveying section 3 includes a first conveying path SP1, a second conveying path SP2, and a third conveying path SP3. As shown in FIG. 1 and FIG. 3, the first conveying path SP1 extends so as to pass through the fixing apparatus 130 so that the sheet S is conveyed rearward (in a predetermined conveying direction). The second conveying path SP2 and the third conveying path SP3 are conveying paths formed on a downstream side of the first conveying path SP1 in the conveying direction by diverging from the first conveying path SP1 so that the sheet S is selectively conveyed along the second conveying path SP2 or along the third conveying path SP3. The second conveying path SP2 extends in a vertical direction along a rear wall 245. The second conveying path SP2 extends through the conveying roller pair 133 to the upper discharge roller pair 134. That is, the sheet S is discharged into the sheet discharge section 210 via the second conveying path SP2. On the other hand, the third conveying path SP3 is a conveying path extending from the first conveying path SP1 toward the rear wall 245. The sheet S conveyed into the third conveying path SP3 is discharged to the outside of the rear wall 245 via a slit-like discharge opening 245S (FIG. 3) (side discharge section) formed in the rear wall 245. A sheet discharge tray (not shown in the drawings) installed at the discharge opening 245S allows the sheet S to be discharged into the sheet discharge tray via the third conveying path SP3. Any post-processing apparatus or the like may be connected to the discharge opening 245S.

The sheet conveying section 3 includes a sheet guide 30 (switching guide), a discharge roller 31 (conveying roller), a driven roller 32, and an intermediate conveying roller pair 33.

The sheet guide 30 switches the conveying path along which the sheet S from the first conveying path SP1 is conveyed, between the second conveying path SP2 and the third conveying path SP3. The sheet guide 30 allows the position thereof to be changed between a first position in which the sheet S is conveyed into the second conveying path SP2 and a second position in which the sheet S is conveyed into the third conveying path SP3. As described above, FIG. 3 shows that the sheet guide 30 is placed in the first position, and FIG. 4 shows that the sheet guide 30 is placed in the second position. A control section (not shown in the drawings) arranged in the printer 100 changes the position of the sheet guide 30 in accordance with a destination to which the sheet S is discharged.

The discharge roller 31 is arranged on the third conveying path SP3 to convey the sheet S conveyed from the first conveying path SP1 toward the discharge opening 245S. The discharge roller 31 is rotatably supported by a guide unit 40 described below. Furthermore, the discharge roller 31 is rotationally driven by a driving mechanism 6 described below. The driven roller 32 is arranged above and opposite the discharge roller 31. The driven roller 32 is rotatably supported by a frame (not shown in the drawings) in the housing 200. The driven roller 32 rotates in conjunction with the discharge roller 31. The sheet S is conveyed while passing between the discharge roller 31 and the driven roller 32. The intermediate conveying roller pair 33 is arranged on a downstream side of the fixing apparatus 130 in the conveying direction. The intermediate conveying roller pair 33 conveys the sheet S toward the sheet guide 30. The sheet S conveyed by the intermediate conveying roller pair 33 is guided by the sheet guide 30 and conveyed into the second conveying path SP2 or into the third conveying path SP3.

Thus, in the present embodiment, the sheet S from the first conveying path SP1 is selectively conveyed into the second conveying path SP2 or into the third conveying path SP3. The discharge roller 31 is arranged on the third conveying path SP3. In other words, when the sheet S is conveyed into the second conveying path SP2, the discharge roller 31 need not be rotated. Conventionally, for example, when the sheet S are consecutively conveyed into the second conveying path SP2, unwanted rotation of the discharge roller 31 may facilitate wear of the discharge roller 31 and the driven roller 32 in conjunction with the rotation. Furthermore, conventionally, unwanted rotation sound may disadvantageously be generated in conjunction with the rotation of the discharge roller 31.

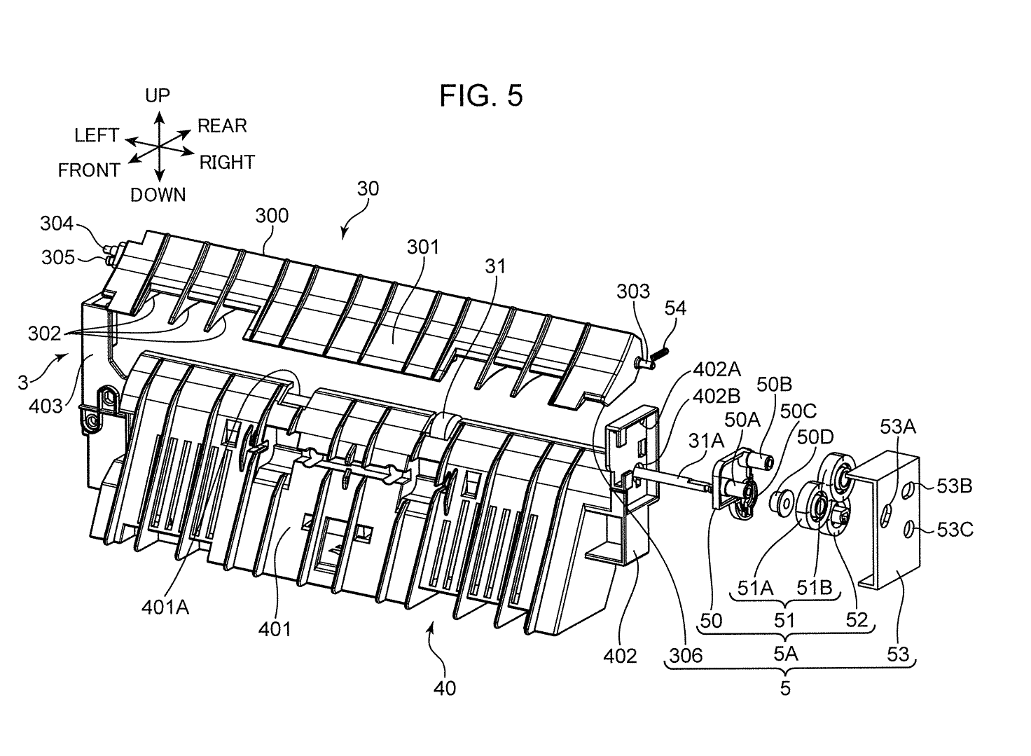

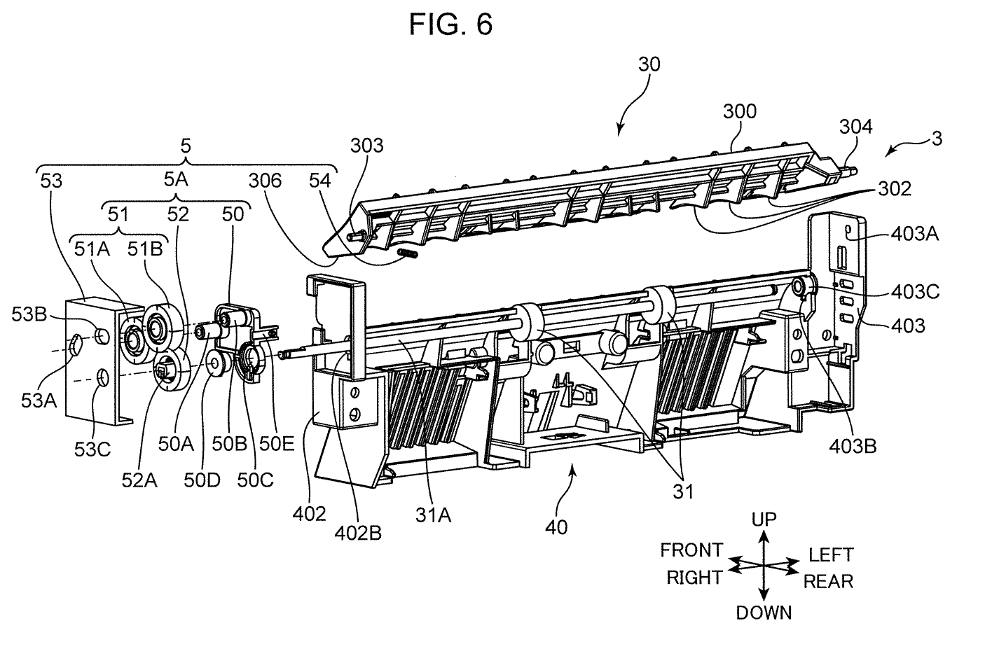

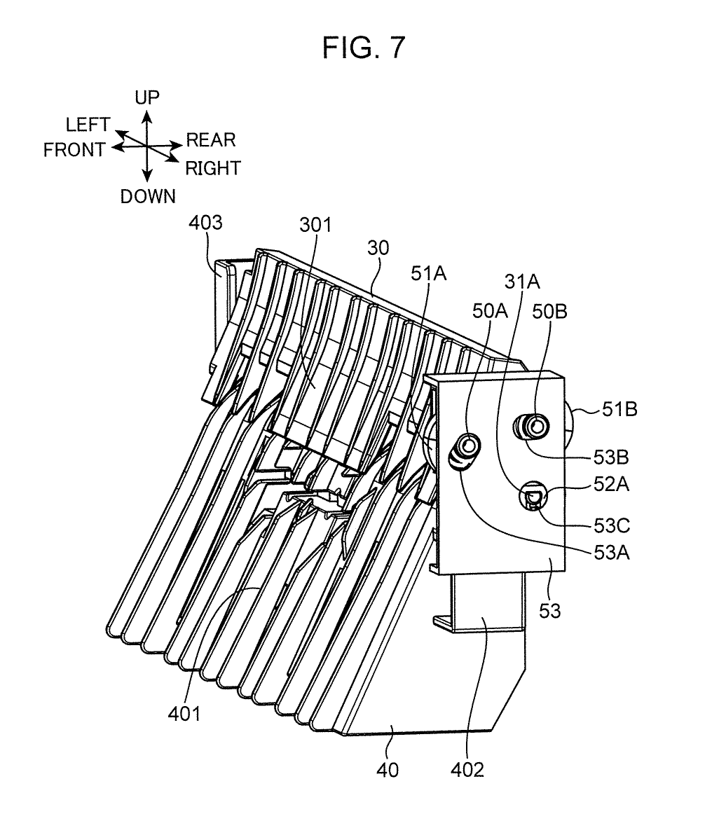

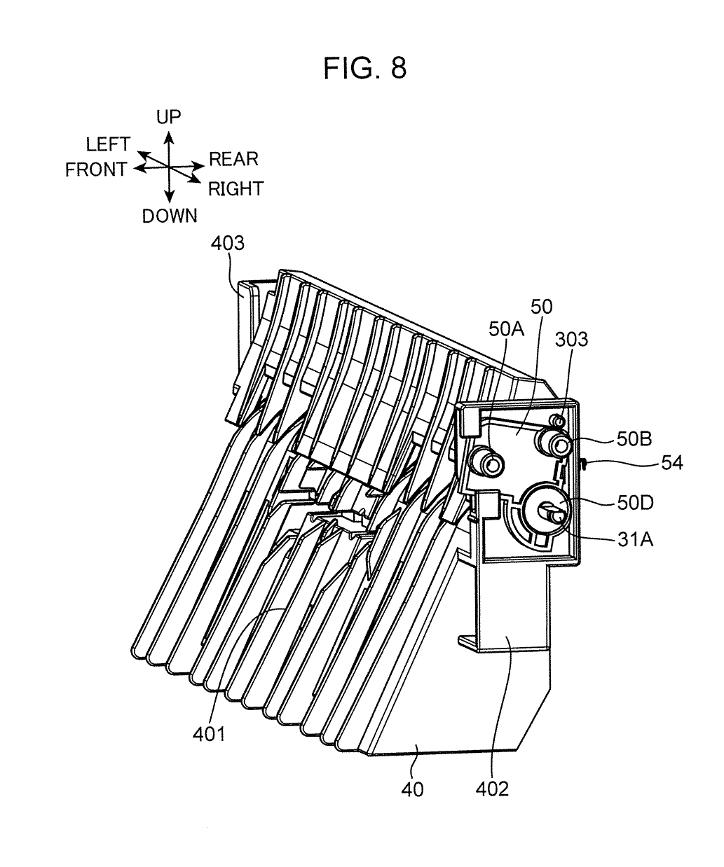

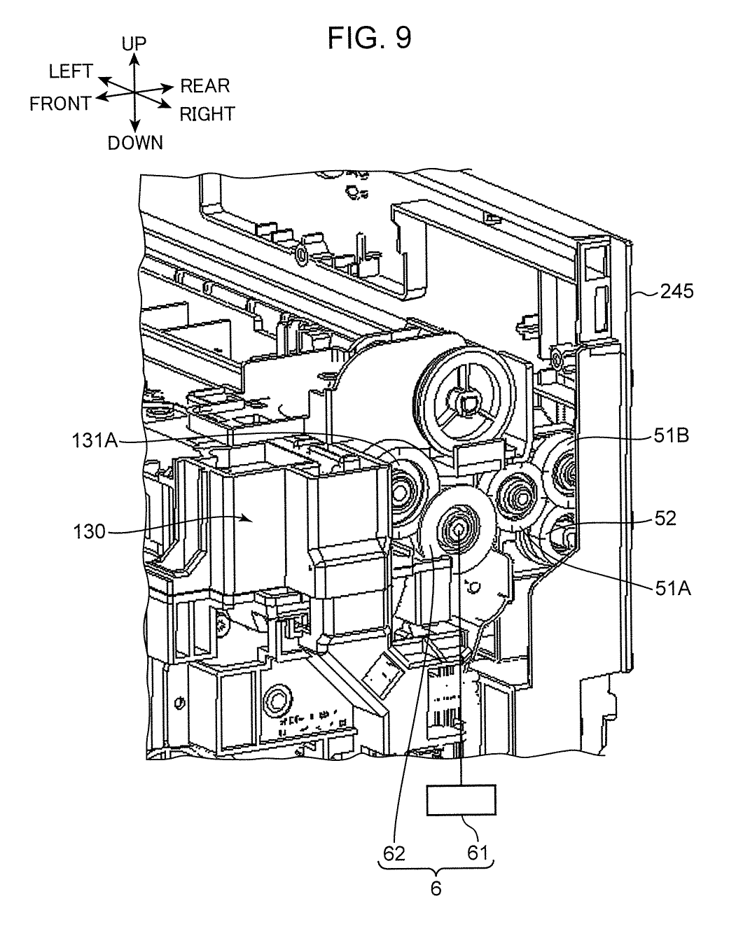

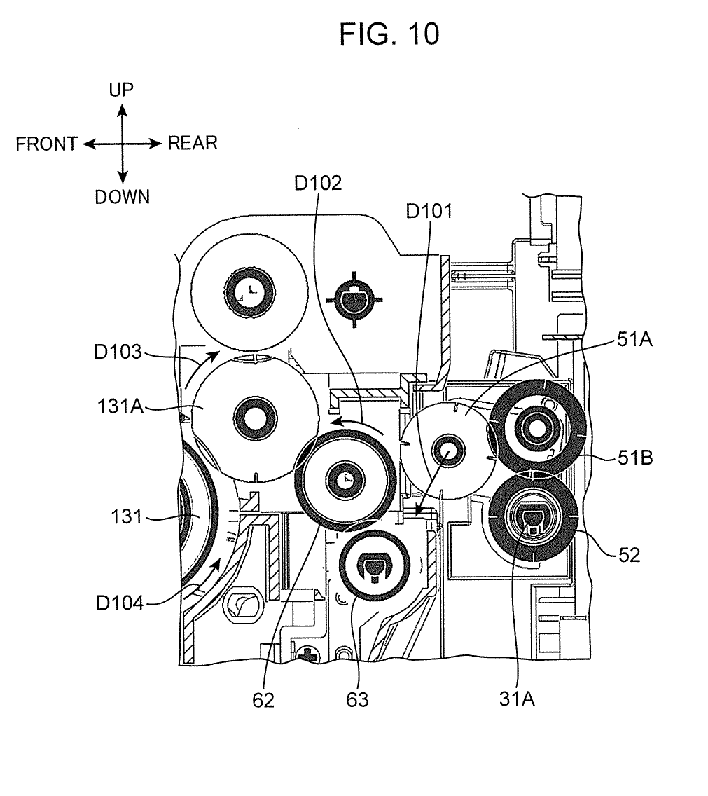

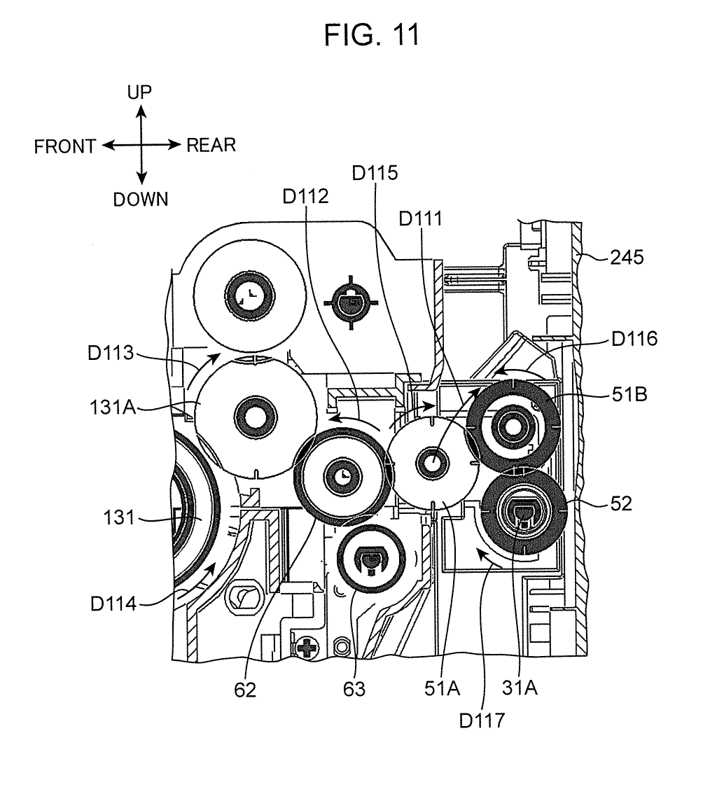

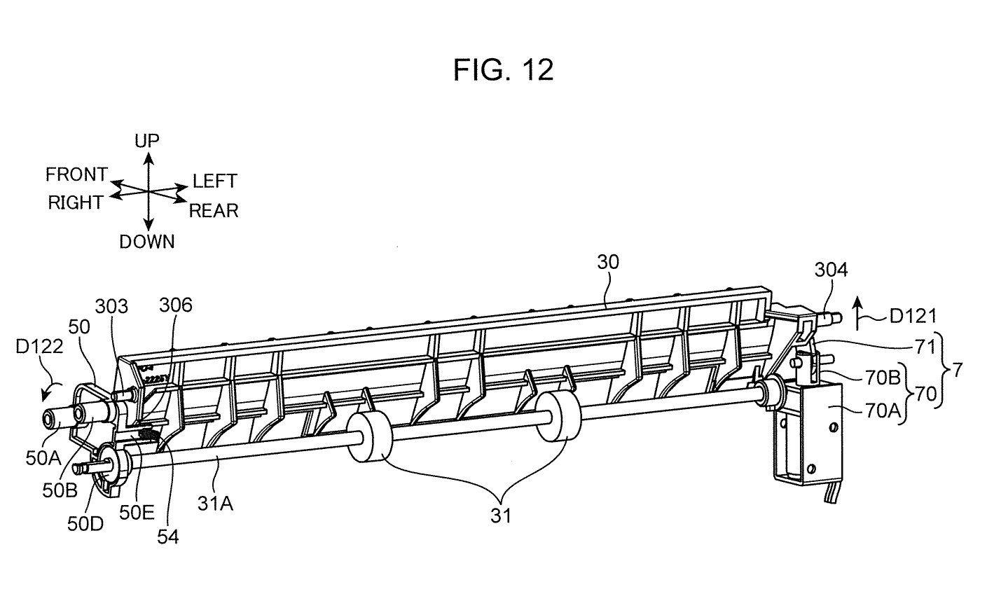

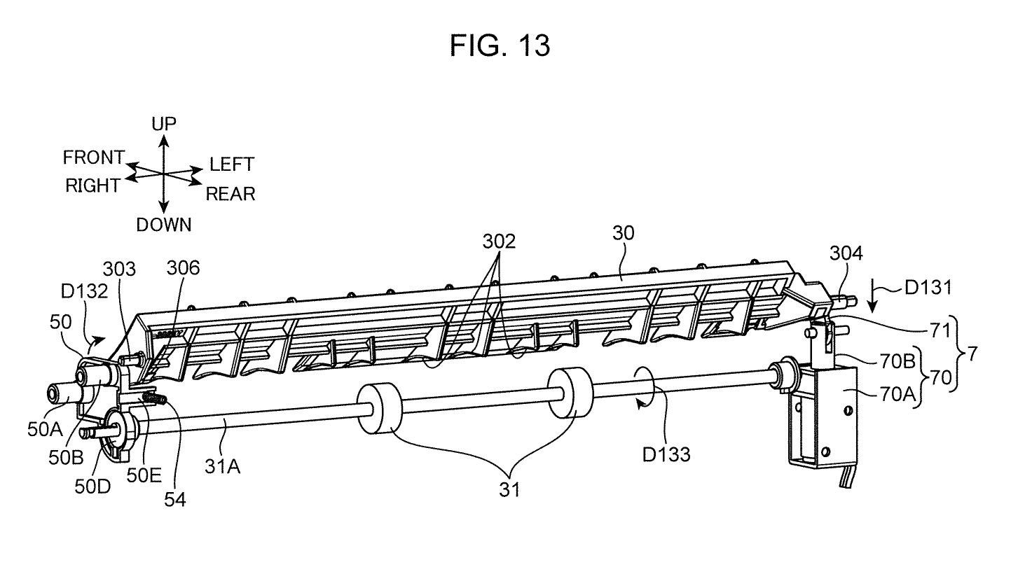

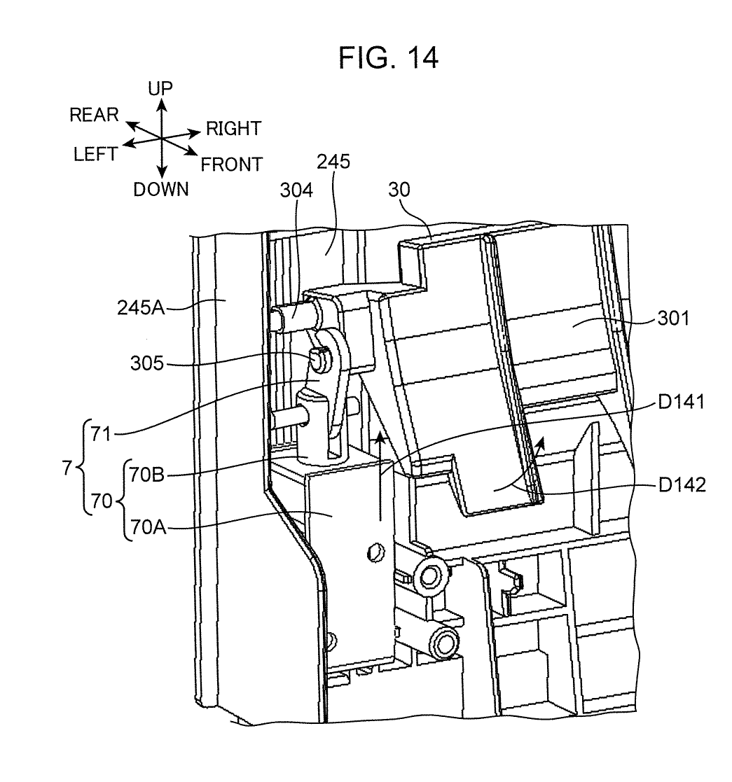

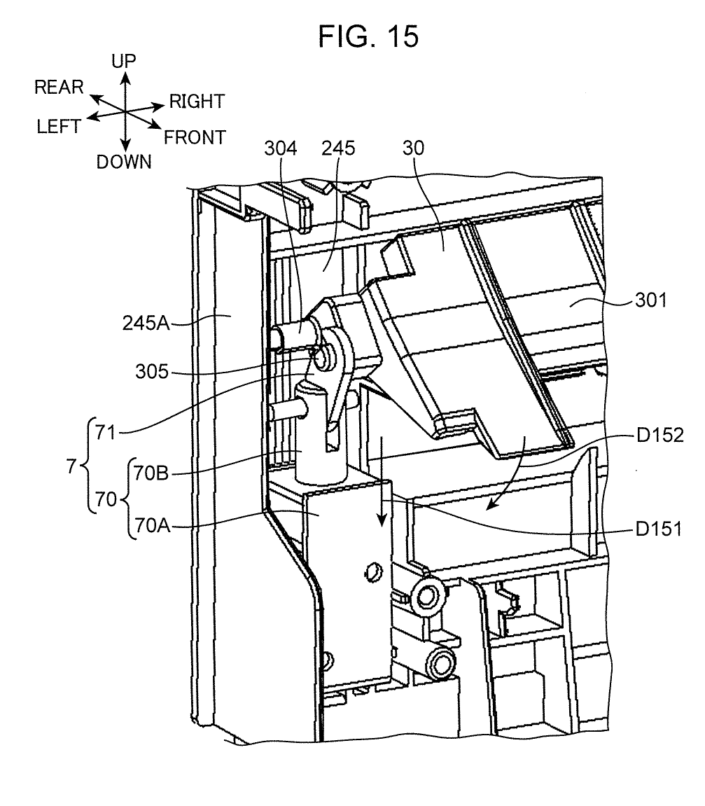

According to the present embodiment, to solve such problems, the sheet conveying section 3 rotationally drives the discharge roller 31 in accordance with the destination into which the sheet S is conveyed. Now, with reference to FIG. 5 to FIG. 15, the structure and functions of the sheet conveying section 3 will be described below in further detail. FIG. 5 and FIG. 6 are exploded perspective views of the sheet conveying section 3 according to the present embodiment. FIG. 7 and FIG. 8 are perspective views of the sheet guide 30 and a guide unit 40 in the sheet conveying section 3 according to the present embodiment. FIG. 8 corresponds to FIG. 7 in which a support frame 53 described below has been removed. FIG. 9 is a perspective view of the periphery of the driving mechanism 6 of the sheet conveying section 3. FIG. 10 and FIG. 11 are cross-sectional views of the periphery of a driving transmission mechanism of the sheet conveying section 3. FIG. 10 corresponds to a case where the sheet guide 30 is placed in the first position. FIG. 11 corresponds to a case where the sheet guide 30 is placed in the second position. FIG. 12 and FIG. 13 are perspective views of the periphery of the sheet guide 30 of the sheet conveying section 3. FIG. 12 corresponds to the case where the sheet guide 30 is placed in the first position. FIG. 13 corresponds to the case where the sheet guide 30 is placed in the second position. FIG. 14 and FIG. 15 are enlarged perspective view of the periphery of a moving mechanism 7 of the sheet guide 30. FIG. 14 corresponds to the case where the sheet guide 30 is placed in the first position. FIG. 15 corresponds to the case where the sheet guide 30 is placed in the second position.

As shown in FIG. 5 and FIG. 6, the sheet conveying section 3 includes, in addition to the sheet guide 30 and the discharge roller 31, the guide unit 40, a roller shaft 31A, and a transmission mechanism 5.

The sheet guide 30 is a member extending in a sheet width direction (lateral direction) crossing the sheet conveying direction and is shaped generally like a triangle in section as viewed in a front-rear direction and in the up-down direction. The sheet guide 30 includes a guide main body 300, a first support shaft 303 and a second support shaft 304 (guide shaft section), and an engaging shaft section 305.

The guide main body 300 extends along an axial direction (sheet width direction) of the roller shaft 31A described below. The guide main body 300 is a main body section of the sheet guide 30. The guide main body 300 includes a first guide surface 301 and a second guide surface 302.

The first guide surface 301 corresponds to one of the surfaces of the guide main body 300 extending in the sheet width direction. When the sheet guide 30 is in the first position, the sheet S conveyed from the intermediate conveying roller pair 33 is conveyed into the second conveying path SP2 in abutting contact with the first guide surface 301. The first guide surface 301 includes a plurality of ribs formed thereon and arranged at intervals in the lateral direction as shown in FIG. 5.

The second guide surface 302 corresponds to the other of the surfaces of the guide main body 300 extending in the sheet width direction. That is, the second guide surface 302 is arranged on a back surface of the first guide surface 301. When the sheet guide 30 is in the second position, the sheet S conveyed from the intermediate conveying roller pair 33 is conveyed into the third conveying path SP3 in abutting contact with the second guide surface 302. The second guide surface 302 is leading end portions of the plurality of ribs arranged at intervals in the lateral direction as shown in FIG. 5 and FIG. 6. The leading end portions of the plurality of ribs are curved so as to guide the sheet S toward the discharge roller 31.

The first support shaft 303 and the second support shaft 304 are arranged on a right sidewall and a left sidewall, respectively, of the guide main body 300. The first support shaft 303 and the second support shaft 304 are each arranged in a portion of the corresponding sidewall of the guide main body 300 which is located on a downstream side in the conveying direction for the sheet S. The first support shaft 303 and the second support shaft 304 are shaft sections extending from the guide main body 300 in the sheet width direction. The first support shaft 303 projects rightward from the right sidewall of the guide main body 300. The second support shaft 304 projects leftward from the left sidewall of the guide main body 300. The first support shaft 303 is inserted through a first bearing hole 402A in the guide unit 40 described below. The second support shaft 304 is inserted through a second bearing hole 403A in the guide unit 40. The guide main body 300 moves rotationally around the first support shaft 303 and the second support shaft 304 to allow the sheet guide 30 to change the position thereof between the first position and the second position.

The engaging shaft section 305 is a projecting portion arranged on the left sidewall of the guide main body 300 below the second support shaft 304. The engaging shaft section 305 projects leftward from the sidewall and includes a groove (not shown in the drawings) at a leading end portion of the engaging shaft section 305. One end of a link 71 of the moving mechanism 7 described below is engaged with the groove in the engaging shaft section 305.

The guide unit 40 is a unit arranged inside the housing 200 below the sheet guide 30. The guide unit 40 is arranged on an upstream side of the sheet guide 30 in the conveying direction for the sheet S, to guide the sheet S. The guide unit 40 supports the sheet guide 30 so that the sheet guide 30 is rotationally movable.

The guide unit 40 supports the discharge roller 31 so that the discharge roller is rotationally movable. Furthermore, the guide unit 40 includes a unit guide section 401, a first support wall 402, and a second support wall 403.

The unit guide section 401 is the main body section of the guide unit 40. The unit guide section 401 has a function to guide the sheet S to the third conveying path SP3. As shown in FIG. 5, the unit guide section 401 includes a plurality of ribs arranged thereon at intervals in the lateral direction. Furthermore, the unit guide section 401 includes a pair of cutout portions 401A formed at an upper edge of the unit guide section 401. A pair of discharge rollers 31 is exposed from the cutout portions 401A. The sheet S is conveyed into the third conveying path SP3 while passing between the second guide surface 302 of the sheet guide 30 and the unit guide section 401. Furthermore, as shown in FIG. 2, when the sheet S conveyed to the upper discharge roller pair 134 is conveyed in the opposite direction and conveyed into an opposite conveying path SP4 (FIG. 2), the unit guide section 401 guides the sheet S. The sheet S reaches the image forming section 120 again after being conveyed into the opposite conveying path SP4 so that a toner image formed on a back surface of the sheet S.

The first support wall 402 is a sidewall portion arranged on the right side of the unit guide section 401. The first support wall 402 stands so as to face rightward. The first support wall 402 includes a first bearing hole 402A and a shaft insertion hole 402B. The first bearing hole 402A is a hole portion formed at an upper, rear end portion of the first support wall 402 so as to penetrate the first support wall 402 in the lateral direction. The first support shaft 303 is inserted through the first bearing hole 402A. The shaft insertion hole 402B is a hole portion formed below the first bearing hole 402A so as to penetrate the first support wall 402 in the lateral direction. A roller shaft 31A described below is inserted through the shaft insertion hole 402B.

The second support wall 403 is a sidewall portion arranged on the left side of the unit guide section 401. The second support wall 403 is a wall portion shaped like the character L as viewed in plan and stands so as to face forward and leftward. As shown in FIG. 6, the second support wall 403 includes a second bearing hole 403A, a second roller bearing section 403B, and a second bearing piece 403C. The second bearing hole 403A is a hole portion formed at an upper, rear end portion of the second support wall 403 so as to penetrate the second support wall 403 in the lateral direction. The second support shaft 304 is inserted through the second bearing hole 403A. The second roller bearing section 403B is a C-shaped bearing section arranged near the boundary between the unit guide section 401 and the second support wall 403. The second bearing piece 403C is a bearing fitted into the second roller bearing section 403B. The second bearing piece 403C supports the roller shaft 31A so that the roller shaft 31A is rotatable.

The roller shaft 31A is arranged to extend in the sheet width direction, which crosses the conveying direction for the sheet S, and axially supports the pair of discharge rollers 31 so that the discharge rollers 31 are rotatable. A left end portion of the roller shaft 31A is rotatably supported by the second bearing piece 403C as described above. On the other hand, a right end portion of the roller shaft 31A is rotatably supported by a first bearing piece 50D fitted in a hole portion 50C described below.

The transmission mechanism 5 is arranged opposite a right side (the other end side of the guide main body 300 in the sheet width direction) of the guide main body 300 of the sheet guide 30. A part of the transmission mechanism 5 is installed on a first support wall 402 of the guide unit 40. The transmission mechanism 5 disconnects transmission, to the discharge roller 31, of a rotational driving force generated by the driving mechanism 6 described below, in association with the first position of the sheet guide 30. Furthermore, the transmission mechanism 5 transmits the rotational driving force to the discharge roller 31 in association with the second position of the sheet guide 30. In other words, the transmission mechanism 5 couples a transmission gear section 51 and the driving mechanism 6 together in conjunction with a change in the position of the sheet guide 30 from the first position to the second position which change is made by the moving mechanism 7 described below. Furthermore, the transmission mechanism 5 cancels (uncouples) the coupling between the transmission gear section 51 and the driving mechanism 6 in conjunction with a change in the position of the sheet guide 30 from the second position to the first position which change is made by the moving mechanism 7.

The transmission mechanism 5 includes a discharge roller gear 52 (roller input gear), a rotational moving gear unit 5A, the support frame 53, and a bias spring 54.

The rotational moving gear unit 5A is rotationally movable between the first support wall 402 and the support frame 53. The rotational moving gear unit 5A moves rotationally using the roller shaft 31A as a pivot. The rotational moving gear unit 5A includes a gear plate 50 (gear mounting plate) and the transmission gear section 51.

The gear plate 50 is the main body section of the rotational moving gear unit 5A and is a plate-like member arranged between the first support wall 402 and the support frame 53. The gear plate 50 is provided at one end side of the roller shaft 31A. The gear plate 50 supports the transmission gear section 51 so that the transmission gear section 51 is rotatable, and can swing around the roller shaft 31A with respect to the support frame 53 described below. The gear plate 50 includes a first gear shaft 50A, a second gear shaft 50B, a hole portion 50C, a first bearing piece 50D, and a pressed portion 50E.

The first gear shaft 50A projects rightward from a front portion of the gear plate 50. The first gear shaft 50A is shaped like a cylinder. A first transmission gear 51A is axially supported by the first gear shaft 50A so as to be rotatable.

The second gear shaft 50B projects rightward from a rear, upper portion of the gear plate 50. The second gear shaft 50B is shaped like a cylinder. A second transmission gear 51B is axially supported by the second gear shaft 50B so as to be rotatable.

The hole portion 50C is a hole portion formed in the gear plate 50 below the second gear shaft 50B so as to penetrate the gear plate 50 in the lateral direction. The first bearing piece 50D is a bearing fitted into the hole portion 50C. After penetrating the shaft insertion hole 402B (FIG. 5), the roller shaft 31A is inserted through the first bearing piece 50D. Moreover, the right leading end portion of the roller shaft 31A penetrates the first bearing piece 50D and is inserted through the discharge roller gear 52 described below.

The pressed portion 50E is a rectangular projecting piece projecting leftward from a rear edge of the gear plate 50. The pressed portion 50E is biased forward by the bias spring 54 described below.

The transmission gear section 51 is coupled to the discharge roller gear 52 described below and can be coupled to the driving mechanism 6 also described below. As a result, the transmission gear section 51 can couple the discharge roller gear 52 and the driving mechanism 6 together and cancel the coupling. The transmission gear section 51 has a function to transmit a rotational driving force transmitted from the driving mechanism 6, to the discharge roller gear 52. The transmission gear section 51 includes the first transmission gear 51A and the second transmission gear 51B.

The first transmission gear 51A is axially supported by the first gear shaft 50A so as to be rotatable. The first transmission gear 51A can be coupled to an idler gear 62 of the driving mechanism 6 described below. The first transmission gear 51A transmits a rotational driving force transmitted from the idler gear 62, to the second transmission gear 51B.

The second transmission gear 51B is axially supported by the second gear shaft 50B so as to be rotatable. The second transmission gear 51B is coupled to the discharge roller gear 52. The second transmission gear 51B transmits a rotational driving force transmitted from the first transmission gear 51A, to the discharge roller gear 52.

The discharge roller gear 52 is arranged below the second transmission gear 51B. The discharge roller gear 52 is a gear fixed to the roller shaft 31A and to which a rotational driving force needed to rotate the discharge roller 31 is input. As shown in FIG. 6, the discharge roller gear 52 includes a D surface shaft section 52A. The D surface shaft section 52A projects from a side surface of the discharge roller gear 52. The D surface shaft section 52A is a generally cylindrical portion including an internal space shaped like the character D as viewed in cross section. As described above, the leading end portion of the roller shaft 31A having penetrated the first bearing piece 50D is inserted through the D surface shaft section 52A. At this time, as shown in FIG. 6, the leading end portion of the roller shaft 31A includes a D surface shape corresponding to the shape of the D surface shaft section 52A. Thus, the discharge roller gear 52 is installed on the leading end portion of the roller shaft 31A to enable the discharge roller gear 52 and the roller shaft 31A to be integrally rotated. As a result, the discharge roller 31 rotates with the roller shaft 31A.

The support frame 53 is a frame installed on the first support wall 402 of the guide unit 40. The support frame 53 supports one end of the roller shaft 31A. A space portion in which the rotational moving gear unit 5A is rotationally movable is formed between the support frame 53 and the first support wall 402. The support frame 53 includes a first slot 53A, a second slot 53B, and a first roller bearing section 53C. A leading end portion of the first gear shaft 50A having penetrated the first transmission gear 51A is inserted into the first slot 53A. Similarly, a leading end portion of the second gear shaft 50B having penetrated the second transmission gear 51B is inserted into the second slot 53B. Furthermore, the first roller bearing section 53C is a hole portion that axially supports the D surface shaft section 52A so that the D surface shaft section 52A is rotatable.

As shown in FIG. 5 to FIG. 8, the rotational moving gear unit 5A is rotationally movably supported between the first support wall 402 and the support frame 53. As shown in FIG. 7, the first slot 53A and the second slot 53B are slots formed along the circumferential direction in the rotation of the rotational moving gear unit 5A, which are formed so that the rotational moving gear unit 5A can move rotationally. In conjunction with the rotational movement of the rotational moving gear unit 5A, the first gear shaft 50A moves along the first slot 53A. Furthermore, the second gear shaft 50B moves along the second slot 53B. Additionally, above the second gear shaft 50B, the first support shaft 303 is axially supported by the first support wall 402 as shown in FIG. 8.

The bias spring 54 is a coil spring compressively placed between a frame (not shown in the drawings) in the housing 200 and the pressed portion 50E of the gear plate 50. The bias spring 54 biases the gear plate 50 forward from the frame. In other words, the bias spring 54 biases the gear plate 50 in one direction around the roller shaft 31A so as to couple the transmission gear section 51 to the driving mechanism 6 described below.

Moreover, the transmission mechanism 5 includes a pressing wall portion 306 (pressing portion). The pressing wall portion 306 separates from the pressed portion 50E of the gear plate 50 in conjunction with a change in the position of the sheet guide 30 from the first position to the second position. As a result, the pressing wall portion 306 permits the transmission gear section 51 and the driving mechanism 6 to be coupled together under the biasing force of the bias spring 54. On the other hand, the pressing wall portion 306 comes into abutting contact with the pressed portion 50E of the gear plate 50 in conjunction with a change in the position of the sheet guide 30 from the second position to the first position. As a result, the pressing wall portion 306 rotates (rocks) the gear plate 50, against the biasing force, in a direction opposite to the biasing direction of the bias spring 54 (the direction opposite to the one direction) around the roller shaft 31A, separating the transmission gear section 51 from the driving mechanism 6. The pressing wall portion 306 will further be described. The pressing wall portion 306 separates from the gear plate 50 when the sheet guide 30 is in the first position, to permit the transmission gear section 51 to couple to the driving mechanism 6 under the biasing force of the bias spring 54. Furthermore, the pressing wall portion 306 comes into abutting contact with the gear plate 50 when the sheet guide 30 is in the second position, to uncouple, against the biasing force, the coupling between the transmission gear section 51 and the driving mechanism 6.

Thus, according to the present embodiment, the pressing wall portion 306, a part of the guide main body 300, has a pressing portion function to bring the transmission gear section 51 into contact with the driving mechanism 6 and to separate the transmission gear section 51 from the driving mechanism 6. The pressing wall portion 306 corresponds to a lower edge of the right (the other end portion on the sheet width direction) sidewall of the guide main body 300.

Moreover, as shown in FIG. 9 to FIG. 11, the sheet conveying section 3 includes the driving mechanism 6 (FIG. 9) and an intermediate conveying gear 63 (FIG. 10). Furthermore, the printer 100 includes a heating roller gear 131A (FIG. 10). Moreover, the sheet conveying section 3 includes the moving mechanism 7 (position change mechanism) (FIG. 12 to FIG. 15).

The driving mechanism 6 generates a rotational driving force that rotates the discharge roller 31. Furthermore, according to the present embodiment, the driving mechanism 6 generates a rotational driving force that rotates the heating roller 131 of the fixing apparatus 130. The driving mechanism 6 includes a driving motor 61 and an idler gear 62. The driving motor 61 is a motor that generates the rotational driving force. The idler gear 62 is a gear coupled to a driving shaft (not shown in the drawings) of the driving motor 61. The idler gear 62 is axially supported by the frame (not shown in the drawings) in the housing 200 so as to be rotatable.

The intermediate conveying gear 63 is located below and coupled to the idler gear 62. The intermediate conveying gear 63 is a gear that transmits a rotational driving force to the intermediate conveying roller pair 33. A rotational driving force generated by the driving motor 61 is transmitted to the intermediate conveying roller pair 33 via the idler gear 62 and the intermediate conveying gear 63.

The heating roller gear 131A is located in front of and coupled to the idler gear 62. The heating roller gear 131A is a gear that transmits a rotational driving force to the heating roller 131. The heating roller gear 131A is axially supported by the frame (not shown in the drawings) in the housing 200 so as to be rotatable. A rotational driving force generated by the driving motor 61 is transmitted to the heating roller 131 via the idler gear 62 and the heating roller gear 131A. Then, as described above, the pressure roller 132 (FIG. 2) rotates in conjunction with the heating roller 131 to covey the sheet S along the first conveying path SP1 with a fixing process executed on the sheet S.

As shown in FIG. 12 and FIG. 15, the moving mechanism 7 is arranged opposite a left end portion of the sheet guide 30 (one end side of the guide main body 300 in the sheet width direction). Furthermore, as shown in FIG. 15, the moving mechanism 7 is arranged on a right side of a rear wall left end portion 245A. The rear wall left end portion 245A is a wall portion formed by bending a left end portion of the rear wall 245 forward. In FIG. 15, illustration of the guide unit 40 (FIG. 5) is omitted.

The moving mechanism 7 changes the position of the sheet guide 30 between the first position and the second position. Specifically, the moving mechanism 7 is coupled to one end side (left end side) of the guide main body 300 in the sheet width direction in order to induce the guide main body 300 to rotationally move around the first support shaft 303 and the second support shaft 304. The moving mechanism 7 includes a solenoid 70 and a link 71. The solenoid 70 performs a projecting and retracting operation in order to change the position of the sheet guide 30. The solenoid 70 is controlled by a control section (not shown in the drawings) provided in the printer 100. The solenoid 70 includes a main body section 70A and a projecting and retracting shaft 70B. The main body section 70A is the main body section of the solenoid 70. The projecting and retracting shaft 70B is a shaft section provided to project upward from the main body section 70A. The projecting and retracting shaft 70B projects from and retracts into the main body section 70A in the up-down direction. The link 71 is a link member that couples the guide main body 300 and the projecting and retracting shaft 70B together. As shown in FIG. 15, a lower end portion of the link 71 is rotatably coupled to the projecting and retracting shaft 70B. Similarly, an upper end portion of the link 71 is rotatably coupled to the engaging shaft section 305 of the guide main body 300.

Now, operation of the transmission mechanism 5 in conjunction with a change in the position of the sheet guide 30 will be described.

As shown in FIG. 3, when the sheet S with a fixing process executed on the sheet S by the fixing apparatus 130 is discharged into the discharge section 210, the control section (not shown in the drawings) controls the solenoid 70 to retract the projecting and retracting shaft 70B as shown in FIG. 14. At this time, the link 71 coupled to the projecting and retracting shaft 70B has lowered the engaging shaft section 305 downward, and thus, the leading end portion (lower end portion) of the guide main body 300 extends downward (FIG. 12). As a result, as shown in FIG. 3, the sheet S is conveyed into the second conveying path SP2 (arrow D31 in FIG. 3) while being guided by the sheet guide 30 and discharged into the sheet discharge section 210.

At this time, as shown in FIG. 12, the pressing wall portion 306 of the sheet guide 30 biases the pressed portion 50E rearward against the biasing force of the bias spring 54. Thus, the gear plate 50 is rotationally moved rearward using the roller shaft 31A as a pivot (FIG. 12), separating the first transmission gear 51A from the idler gear 62 (FIG. 10). In this case, a rotational driving force generated by the driving mechanism 6 is transmitted to the heating roller 131 via the idler gear 62 and the heating roller gear 131A (arrows D102, D103, and D104 in FIG. 10). Furthermore, the intermediate conveying roller pair 33 is rotated via the intermediate conveying gear 63. On the other hand, the first transmission gear 51A is separate from the idler gear 62, and thus, the rotational driving force of the idler gear 62 is not transmitted to the first transmission gear 51A. Thus, the discharge roller gear 52 is prevented from rotating, with the rotation of the discharge roller 31 stopped.

As described above, when the sheet S is discharged into the sheet discharge section 210 via the second conveying path SP2, unwanted rotation of the discharge roller 31 is prevented. As a result, possible wear of and damage to the discharge roller 31 and possible noise are prevented which are involved in the unwanted rotation.

On the other hand, in the state shown in FIG. 3, FIG. 10, FIG. 12, and FIG. 14 (the first position of the sheet guide 30), when the destination into which the sheet S is discharged is set to the discharge opening 245S (FIG. 3), the position of the sheet guide 30 is changed to the second position. That is, the control section (not shown in the drawings) controls the solenoid 70 to project the projecting and retracting shaft 70B from the main body section 70A (arrow D121 in FIG. 12 and arrow D141 in FIG. 14). As a result, the link 71 coupled to the projecting and retracting shaft 70B pushes the engaging shaft section 305 upward. Then, the guide main body 300 moves rotationally around the first support shaft 303 and the second support shaft 304 (arrow D142 in FIG. 14) so as to move the leading end portion of the guide main body 300 upward. As a result, the sheet guide 30 is placed into the second position shown in FIG. 4, FIG. 13, and FIG. 15.

As the position of the sheet guide 30 changes, the pressing wall portion 306 (FIG. 12) of the guide main body 300 moves forward away from the pressed portion 50E. As a result, the gear plate 50 is rotationally moved, by the biasing force of the bias spring 54, in the direction of arrow D122 in FIG. 12 using the roller shaft 31A as a pivot. At this time, the first transmission gear 51A moves in the direction of arrow D101 in FIG. 10 to couple to the idler gear 62 (FIG. 11).

When the driving motor 61 is rotated by the control section (not shown in the drawings), the heating roller 131 is rotated via the idler gear 62 and the heating roller gear 131A (arrows D112, D113, and D114 in FIG. 11). Furthermore, the intermediate conveying roller pair 33 is rotated via the intermediate conveying gear 63. Moreover, a rotational driving force is transmitted from the idler gear 62 to the first transmission gear 51A to rotate the second transmission gear 51B and the discharge roller gear 52 (arrows D115, D116, and D117 in FIG. 11). As a result, the discharge roller gear 52 and the roller shaft 31A rotate integrally to rotate the discharge roller 31 in the direction of arrow D133 in FIG. 13. Thus, when the sheet S is conveyed into the third conveying path SP3 by the sheet guide 30 placed in the second position (FIG. 4), the discharge roller 31 is rotated by the driving mechanism 6. As a result, the sheet S is stabilized and conveyed along the third conveying path SP toward the discharge opening 245S (FIG. 4) and then discharged through the discharge opening 245S (arrow D41 in FIG. 4).

Similarly, in the state shown in FIG. 4, FIG. 11, FIG. 13, and FIG. 15 (the second position of the sheet guide 30), when the destination into which the sheet S is discharged is set to the sheet discharge section 210 again, the position of the sheet guide 30 is changed to the first position. That is, the control section (not shown in the drawings) controls the solenoid 70 to retract the projecting and retracting shaft 70B into the main body section 70A (arrow D131 in FIG. 13 and arrow D151 in FIG. 15). As a result, the link 71 coupled to the projecting and retracting shaft 70B pushes the engaging shaft section 305 downward. Then, the guide main body 300 moves rotationally around the first support shaft 303 and the second support shaft 304 (arrow D152 in FIG. 15) so as to move the leading end portion of the guide main body 300 downward. As a result, the sheet guide 30 is placed into the first position again shown in FIG. 3, FIG. 12, and FIG. 14.

As the position of the sheet guide 30 changes, the pressing wall portion 306 of the guide main body 300 (FIG. 12) moves rearward and comes into abutting contact with the pressed portion 50E. As a result, the gear plate 50 moves rotationally in the direction of arrow D132 in FIG. 13 using the roller shaft 31A as a pivot while compressing the bias spring 54. At this time, the first transmission gear 51A moves in the direction of arrow D111 in FIG. 11 to separate from the idler gear 62 (FIG. 10). Thus, the force required for the solenoid 70 to switch the position of the sheet guide 30 is preset higher than the biasing force of the bias spring 54.

As described above, according to the present embodiment, the discharge roller 31 is rotated in association with the case where the sheet S is conveyed into the third conveying path SP3. Thus, the unwanted rotation of the discharge roller 31 is prevented. Furthermore, the transmission of the rotational driving force to the discharge roller 31 can be switched by coupling the transmission gear section 51 and the driving mechanism 6 together and uncoupling the coupling. Moreover, the gear plate 50, the bias spring 54, and the pressing wall portion 306 enable the coupling of the transmission gear section 51 and the driving mechanism 6 and cancellation of the coupling. In particular, the rotational movement of the gear plate 50 utilizing the roller shaft 31A as a hinged pivot makes a space occupied by the sheet conveying section 3 as small as possible, while enabling the coupling and the cancellation of the coupling. Moreover, rotational movement of the gear plate 50 allows the transmission of the rotational driving force to the discharge roller gear 52 to be switched without moving the axial position of the roller shaft 31A, which supports the discharge roller 31.

Furthermore, in the present embodiment, a part of the sheet guide 30 is utilized as a pressing portion that rotationally moves the gear plate 50, allowing the transmission gear section 51 to be separated from the driving mechanism 6. Thus, compared to a case where another pressing portion is adopted, the present embodiment enables the transmission mechanism 5 to be made more compact. Additionally, the gear plate 50 can be rotationally moved utilizing the turning force of the sheet guide 30, rotated around the first support shaft 303 and the second support shaft 304 by the moving mechanism 7.

Furthermore, according to the present embodiment, the moving mechanism 7 is arranged on one end side of the guide main body 300 of the sheet guide 30, and the transmission mechanism 5 is arranged on the other end side of the guide main body 300. Thus, the opposite end sides of the sheet guide 30 in the sheet width direction are effectively utilized. The space occupied by the sheet conveying section 3 is made as small as possible, with coupling of the transmission gear section 51 and the driving mechanism 6 and cancellation of the coupling enabled. Additionally, a part of the other end side of the guide main body 300 can be utilized to separate the transmission gear section 51 from the driving mechanism 6.

Moreover, according to the present embodiment, the sheet S with a fixing process executed thereon is selectively conveyed to the two conveying paths (second conveying path SP2 and third conveying path SP3). Furthermore, the driving mechanism 6 has both the function to rotationally drive the heating roller 131 of the fixing apparatus 130 and the function to rotationally drive the discharge roller 31. In other words, the discharge roller 31 can be selectively rotated utilizing the driving mechanism 6 that rotates the heating roller 131. Then, the sheet S with the fixing process executed thereon is selectively discharged into the sheet discharge section 210 arranged in the upper portion of the housing 200 or into the discharge opening 245S (side discharge section) arranged in the rear wall 245 located on the rear side of the housing 200.

The sheet conveying section 3 and the printer 100 (image forming apparatus) having the same according to the embodiment of the disclosure have been described. However, the disclosure is not limited to the embodiment. For example, the following variations are possible.

(1) According to the embodiment, the moving mechanism 7 that changes the position of the sheet guide 30 has been described using the solenoid 70. However, the disclosure is not limited to this. Another moving mechanism (position change mechanism) such as a driving motor or a cam mechanism may be applied as the moving mechanism 7.

(2) Furthermore, in the embodiment, the aspect has been described in which the transmission gear section 51 that transmits a rotational driving force to the discharge roller gear 52 includes two gears, the first transmission gear 51A and the second transmission gear 51B. However, the disclosure is not limited to this. The transmission gear section 51 may include one gear or three or more gears.

(3) Additionally, in the embodiment, the aspect has been described in which the sheet conveying section 3 conveys the sheet S with a fixing process executed on the sheet S by the fixing apparatus 130. However, the disclosure is not limited to this. The sheet conveying section 3 may be applied to another conveying area in which the sheet S is conveyed from the first conveying path SP1 to the second conveying path SP2 or the third conveying path SP3. In addition, the sheet conveying section 3 may be applied to a post-processing apparatus with a sort function to allow the sheet S to be selectively discharged to a plurality of destinations.

Although the present disclosure has been fully described by way of example with reference to the accompanying drawings, it is to be understood that various changes and modifications will be apparent to those skilled in the art. Therefore, unless otherwise such changes and modifications depart from the scope of the present disclosure hereinafter defined, they should be construed as being included therein.

What is claimed is:

1. A sheet conveying apparatus comprising:
a first conveying path along which a sheet is conveyed in a predetermined conveying direction;
a second conveying path and a third conveying path formed on a downstream side of the first conveying path in the conveying direction by diverging from the first conveying path so that the sheet is selectively conveyed along the second conveying path or along the third conveying path;
a switching guide arranged to extend in a sheet width direction crossing the conveying direction and switching the conveying path, to which the sheet conveyed from the first conveying path, between the second conveying path and the third conveying path, the switching guide enabling an position thereof to be changed between a first position in which the sheet is conveyed into the second conveying path and a second position in which the sheet is conveyed into the third conveying path;
a conveying roller arranged on the third conveying path to convey the sheet conveyed from the first conveying path;
a roller shaft arranged to extend in the sheet width direction and axially supporting the conveying roller rotatably;
a driving mechanism that generates a rotational driving force that rotates the conveying roller;
a transmission mechanism that disconnects transmission of the rotational driving force to the conveying roller in the first position of the switching guide and that transmits the rotational driving force to the conveying roller in the second position of the switching guide; and
an position change mechanism that changes the position of the switching guide between the first position and the second position.

2. The sheet conveying apparatus according to claim 1, wherein the transmission mechanism includes:
a roller input gear which is fixed to the roller shaft and to which the rotational driving force for rotating the conveying roller is input; and
a transmission gear section that enables the roller input gear and the driving mechanism to be coupled and also to be uncoupled, the transmission gear section transmitting the rotational driving force, transmitted from the driving mechanism, to the roller input gear,
wherein the transmission mechanism couples the transmission gear section and the driving mechanism together in conjunction with a change in the position of the switching guide from the first position to the second position, with the change being made by the position change mechanism, and the transmission mechanism uncouples the coupling between the transmission gear section and the driving mechanism in conjunction with a change in the position of the switching guide from the second position to the first position, with the change being made by the position change mechanism.

3. The sheet conveying apparatus according to claim 2, wherein the transmission mechanism further includes:
a support frame that supports one end of the roller shaft;
a gear mounting plate provided at one end of the roller shaft to support the transmission gear section rotatably, the gear mounting plate being able to swing around the roller shaft with respect
to the support frame; and
a bias member that biases the gear mounting plate in one direction around the roller shaft so as to couple the transmission gear section to the driving mechanism, and
the switching guide includes:
a pressing portion that separates from the gear mounting plate, when the switching guide is in the first position, to permit the transmission mechanism to couple to the driving mechanism under a biasing force of the bias member, and that comes into abutting contact with the gear mounting plate, when the switching guide is in the second position, to swing the gear mounting plate against the biasing force, thereby uncoupling the coupling of the transmission gear section to the driving mechanism.

4. The sheet conveying apparatus according to claim 3, wherein the switching guide includes:
a guide main body arranged along the sheet width direction; and
a guide shaft section that extend from the guide main body in the sheet width direction,
the guide main body moves rotationally around the guide shaft section to cause the switching guide to change the position thereof between the first position and the second position,
the position change mechanism is coupled to one end side of the guide main body in the sheet width direction to rotationally move the guide main body around the guide shaft;
the transmission mechanism is arranged opposite another end side of the guide main body in the sheet width direction, and
the pressing portion is arranged on another end side of the guide main body in the sheet width direction, the pressing portion coming into contact with and separating from the gear mounting plate in conjunction with rotational movement of the guide main body around the guide shaft.

5. The sheet conveying apparatus according to claim 4, further comprising:
a guide unit arranged on an upstream side of the switching guide in the conveying direction to guide the sheet, the guide unit including a pair of sidewalls arranged at opposite end portions of the guide unit in the sheet width direction, wherein
the guide shaft section and the roller shaft are rotationally movably supported on the pair of sidewalls.

6. An image forming apparatus comprising:
an apparatus main body;
an image forming section arranged in the apparatus main body to form a toner image on a sheet; and
the sheet conveying apparatus according to claim 1.

7. The image forming apparatus according to claim 6, further comprising:
a fixing section including a rotationally driven roller member that executes a process of fixing the toner image on the sheet, wherein
the sheet conveying apparatus conveys the sheet on which the fixing process has been executed, and
the driving mechanism further rotationally drives the roller member of the fixing section.

8. The image forming apparatus according to claim 7, wherein the first conveying path extends so as to pass at least the fixing section,
the image forming apparatus further comprising:
an upper surface sheet discharge section arranged in an upper surface portion of the apparatus main body and into which the sheet is discharged via the second conveying path; and
a side discharge section arranged in a side surface section of the apparatus main body and into which the sheet is discharged via the third conveying path.
